(19) United States
(12) Patent Application Publication
(10) Pub. No.: US 2009/0307329 A1
(43) Pub. Date: Dec. 10, 2009

(54) ADAPTIVE FILE PLACEMENT IN A DISTRIBUTED FILE SYSTEM

(76) Inventors: CHRIS OLSTON, Mountain View, CA (US); Adam Silberstein, San Jose, CA (US); Benjamin Reed, Morgan Hill, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/135,095

(22) Filed: Jun. 6, 2008

(51) Int. Cl. G06F 15/167; G06F 13/00

(52) U.S. Cl. 709/214

(57) ABSTRACT

In a distributed system that includes multiple machines, a scheduler attempts to schedule a task on a machine that is not currently overloaded with work. If a task is scheduled on a machine that does not yet have copies of the portions of the data set on which the task needs to operate, then that machine obtains copies of those portions from other machines that already have them. Whenever a “source” machine ships a copy of a portion to another “destination” machine in the distributed system, the destination machine persistently stores that copy on the destination machine's persistent storage mechanism. The copy also remains on the source machine. Thus, portions of the data set are automatically replicated whenever those portions are shipped between machines of the distributed system. Each machine in the distributed system has access to “global” information that indicates which machines have which portions of the data set.

### FIELD OF THE INVENTION

The present invention relates to file storage systems, and, more specifically, to techniques for selectively replicating files among the several machines of a distributed file system.

### BACKGROUND

In a very large distributed file system, a large quantity of separate machines (e.g., computers with hard disk drives) may collectively store the file system's data. Taken as a whole, the data stored on the distributed file system's machines forms a data set. The data set may represent various kinds of information. For example, the data set may represent logs of transactions that occurred in web-based system.

Often, computational tasks need to be performed on such a data set. When a task is performed relative to the portion of data that is stored on a particular machine, the particular machine is forced to do some work, such as reading the portion of data from the machine's hard disk drive. The machine on which the portion of data is stored might also perform, relative to the portion of the data, the actual processing that is required by the task. In order to attempt to produce an environment in which no machine is overloaded with work while other machines sit idle, it is desirable to attempt to spread the data set's data relatively evenly among the machines in the distributed system. Some theoretical approaches might attempt to spread the data set evenly among the machines by randomly selecting the machines on which new portions of the data set will be stored.

If the portion of data on which a task is to be performed is currently stored on a machine that is already heavily loaded with work, it may be possible, in some systems, for the heavily loaded machine to “ship” the portion of data over a network (e.g., a local area network (LAN)) to a less heavily loaded (or completely idle) machine so that the latter machine can perform the processing on the portion of data. However, under circumstances in which the machine that originally stores the portion of data is not overly loaded with work, it is usually preferable for that machine to perform the processing on the portion of data, because shipping data over a network (a) increases the latency of the task (due to the additional time taken for the portion of data to travel over the network) and (b) at least momentarily decreases the unused network bandwidth. If too much data shipping occurs in the distributed system, then the network may become saturated, and the latency of the tasks performed in the distributed system may increase significantly. Thus, ideally, data shipping should be minimized. The need to ship data can be reduced by attempting to balance the distributed system's workload as evenly as possible among the distributed system's machines. Spreading the data set relatively evenly among the distributed system's machines helps to achieve this balance.

Often, a single task will involve performing an operation relative to two distinct portions of the data set. For example, in a database system, a “join” operation involves combining values from the columns of one relational table with values from the columns of another relational table. Under circumstances in which a single task involves performing an operation relative to two distinct portions of the data set, it is desirable for both of those portions to be co-located on the same machine. If both of the portions are co-located on the same machine, then that machine can perform all of the processing that is required by the task, and neither of the portions will need to be shipped over the network to any other machine. When it is known that two specific portions of data are likely to be involved in the same tasks with a high frequency, it can be beneficial to attempt to ensure that those portions are stored on the same machine. Unfortunately, under approaches in which portions of the data set are randomly placed among the distributed file system's machines, there is only a random chance that such portions actually will end up stored on the same machine.

Some portions of data might be operated upon more frequently than other portions of data are. For example, recent sales statistics might be the subject of a greater number of tasks than sales statistics that are older. In some distributed systems, it is possible to replicate portions of data so that multiple copies of a particular portion of data are stored on multiple separate machines. When multiple copies of a particular portion of data exist on multiple machines, then it becomes possible for any one of those machines to perform tasks that involve the particular portion of data. As a particular portion of data is replicated more and more among a distributed system's machines, the need to ship the particular portion of data over a network to another machine becomes less and less, since the machine on which a task that operates upon the particular portion is scheduled is likely to already store a copy of the particular portion of data. However, although it may be desirable to replicate some portions of data among a distributed system's machines to some extent, the amount of storage available in a distributed system will always be constrained by some limit. It is not usually possible for the complete data set to be stored on every single machine in the distributed system. Therefore, a choice often needs to be made as to which portions of the data set will be replicated, and how many copies of each of those portions will concurrently exist. It is often desirable to replicate portions of the data set that are more frequently operated upon to a greater extent than portions of the data set that are less frequently operated upon.

A human system analyst might estimate that a certain portion of the data set will be more highly accessed than other portions of the data set. However, for certain kinds of data, it is extremely difficult, if not impossible, for a human system analyst to estimate accurately which portions of the data set will be more highly accessed. Some data sets are constantly changing in composition and character. Sometimes the nature of the data set is highly unpredictable, so that very few accurate predictions about the data set can be made anytime before the data is actually stored. It is usually not practical for a human system operator to estimate continuously which portions of the data set ought to be replicated and the extent to which those portions ought to be replicated. As a system becomes larger and more complex, it becomes increasingly difficult for a human system operator to decide where portions of the data set ought to be placed.

As is discussed above, where it is known that two distinct portions of the data set are frequently going to be involved in the same tasks' operations, it may be desirable to attempt to store both of those portions on the same machine. However, under circumstances where two distinct portions of the data set are both frequently going to be operated upon, but usually not by the same tasks' operations, it is desirable to attempt to ensure that those portions are not stored on the same machine. If two frequently operated-upon portions of the data set are located on the same machine, then that machine is likely to become overloaded with work, making the need to ship one or both portions to another machine more likely. Therefore, unless it is known that two distinct, frequently-accessed portions of data are usually both going to be involved in the same tasks' operations, it is desirable to attempt to ensure that those portions are not stored on (or, at least, not only stored on) the same machine. Once again, though, it is often extremely difficult for a human system analyst to determine which portions of a data set are going to be accessed more frequently than others, and which portions of a data set are going to be accessed in conjunction with other portions of that data set. A human system analyst often will not even have access to source code that might provide some insight as to data access patterns.

These are some of the difficulties faced by designers of distributed file systems. Ideally, the distribution and replication goals discussed above would be achieved in a distributed file system. Unfortunately, there apparently has not yet been any distributed file system that consistently achieves any of these goals. Even if it is generally known that the replication of highly accessed portions of a data set is a desirable goal, approaches for accurately and consistently identifying these portions and replicating these portions to the proper extent are not yet publicly known.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Various embodiments of the present invention are illustrated by way of example, and not by way of limitation, in the figures of the accompanying drawings and in which like reference numerals refer to similar elements and in which:

FIG. 1 is a block diagram that illustrates an example of a distributed file system in which embodiments of the invention may be implemented and practiced;

FIG. 2 is a flow diagram that illustrates an example of a replication technique that may be performed locally by any or all of the machines of a distributed system, according to an embodiment of the invention; and

FIG. 3 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

According to techniques described herein, in a distributed system that includes multiple machines, an automated scheduler attempts to schedule a task on a machine that is not currently overloaded with work, even if that machine does not yet store, on its persistent storage mechanism (e.g., hard disk drive), copies of the portions of the data set on which that task needs to operate. If a task is scheduled on a machine that does not yet have copies of the portions of the data set on which the task needs to operate, then that machine obtains copies of those portions from other machines that already have those portions. According to one embodiment of the invention, whenever a “source” machine ships a portion of a data set to another “destination” machine in the distributed system, the destination machine makes a persistent, local copy of that portion on the destination machine's persistent storage mechanism. The portion also remains on the source machine. Thus, portions of the data set are automatically replicated whenever those portions are shipped between machines of the distributed system. Each machine in the distributed system has access to “global” information that indicates which machines have which portions of the data set.

For example, if a destination machine lacks a particular file on which the destination machine needs to perform some operation, then the destination machine may determine that the source machine has the particular file, and may ask the source machine to ship the particular file over the network to the destination machine. In response to the destination machine's request for the particular file, the source machine ships a copy of the particular file to the destination machine. The source machine retains a persistent copy of the particular file (e.g., on the source machine's hard disk drive). Upon receiving the copy of the particular file from the source machine, the destination machine persistently stores the copy of the particular file on the destination machine's hard disk drive. The destination machine updates globally available (i.e., available to all machines of the distributed system) information to indicate that the particular file is now also available on the destination machine also. Consequently, the particular file is automatically replicated.

According to additional techniques described herein, whenever the persistent storage mechanism (e.g., hard disk drive) of any machine of the distributed system becomes filled beyond a specified threshold (e.g., 90% of the storage mechanism's total capacity), then the machine that contains the storage mechanism selects one or more portions of the data set for eviction. The machine removes the selected portions of the data from its storage mechanism and updates the globally available information to indicate that the selected portions are no longer available on that machine. There are numerous ways by which a machine can decide which portions of the data set stored on the machine's storage mechanism will be evicted from that storage mechanism. Some of these ways are based at least in part on the recent “utility” of those portions, and are discussed in greater detail below.

Due to the application of techniques described herein, the more popular (i.e., more frequently accessed) portions of the data set automatically become replicated to more machines than less popular portions of the data set do. Thus, more machines of the distributed system become available to perform tasks on those popular portions of the data set, thereby reducing the chance that any single machine will become overworked due to being one of the few machines that contains a copy of the popular portions of the data set. Additionally, portions of the data set that tasks frequently operate upon in conjunction with each other will automatically tend to end up being replicated on the same machine. Furthermore, two separate portions of the data set that tasks frequently operate upon, but not in conjunction with the other of the two portions, will automatically tend to end up not being replicated on the same machine.

Other features that may be included in various different embodiments of the invention are also discussed in more detail below.

### Example Distributed File System with Metadata Server and Scheduler

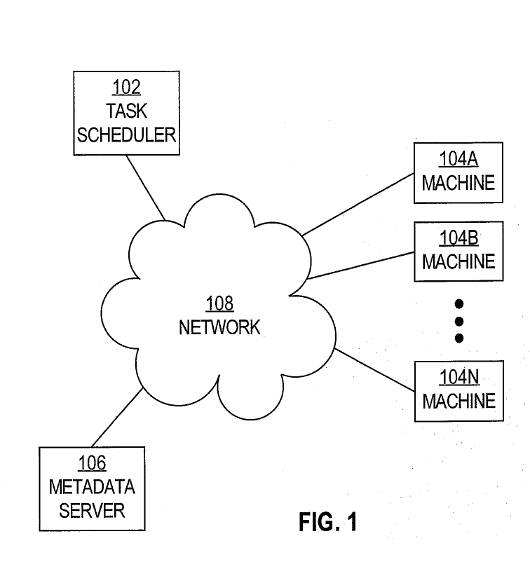

FIG. 1 is a block diagram that illustrates an example of a distributed file system in which embodiments of the invention may be implemented and practiced. The system of FIG. 1 comprises a task scheduler 102, machines 104A-N (also called “nodes”), and a metadata server 106 (also called a “name server”). Task scheduler 102, machines 104A-N, and metadata server 106 are all communicatively coupled to each other via a network 108 (e.g., a local area network (LAN) or wide area network (WAN)). Alternative embodiments of the invention may include more, fewer, or different components that those illustrated in FIG. 1.

In one embodiment of the invention, each of machines 104A-N is a separate computer that contains one or more microprocessors and a persistent storage mechanism such as a hard disk drive. Each of machines 104A-N stores one or more portions of a data set on its persistent storage mechanism. Each of the portions may be a separate file, for example, or separate fragments of files. A particular portion of the data set may be, and often will be, persistently and concurrently stored on multiple separate machines of machines 104A-N. When copies of a particular portion of the data set are stored on multiple machines, that portion of the data set is said to be “replicated.” The act of making a copy of a particular portion of the data set on a machine on which a copy of that portion does not yet exist, when at least one other copy of that particular portion already exists on at least one other machine, is called “replication.”

In one embodiment of the invention, metadata server 106 stores and maintains global information that indicates, for each portion of the data set, which of machines 104A-N currently persistently store copies of that portion. When a copy of a portion of the data set becomes replicated on a particular one of machines 104A-N, that particular machine informs metadata server 106 that a copy of that portion now exists on that particular machine. Metadata server 106 responsively updates the global information to indicate that the particular machine currently stores a copy of the replicated portion. When a particular machine evicts a copy of a portion of the data set from that machine's persistent storage mechanism, the particular machine informs metadata server 106 that the portion of the data set no longer exists on that machine. Metadata server 106 responsively updates the global information to indicate that the particular machine no longer stores a copy of the evicted portion.

In one embodiment of the invention, task scheduler 102 is a process that executes on a computer (which might be separate from any of machines 104A-N). Task scheduler 102 receives, from users or other processes, tasks that need to be performed on certain portions of the data set. Such tasks may include the creation of an index of a set of web pages that were discovered on the Internet by a web crawler, for example. Task scheduler 102 determines which portions of the data set need to be operated upon by a particular task, and asks metadata server 106 to provide information that indicates which of machines 104A-N currently store copies of those portions of the data set. Metadata server 106 responsively determines which of machines 104A-N currently store copies of the specified portions of the data set, and provides, to task scheduler 102, information that indicates, for each specified portion of the data set, a set of machines that currently stores a copy of that specified portion.

According to one embodiment of the invention, task scheduler 102 has some way of determining which machines, in the set of machines, are currently overloaded with work. In one embodiment of the invention, task scheduler 102 polls each machine in the set of machines to determine how busy that machine is. In such an embodiment of the invention, each machine responds to task scheduler 102 with some indication of how busy that machine is (or, simply, whether or not that machine is currently too busy to perform another task). In an alternative embodiment of the invention, task scheduler 102 maintains information about which of machines 104A-N have been assigned tasks, and the times at which those machines were assigned those tasks.

Regardless of how task scheduler 102 determines which machines in the set of machines are currently overloaded with work, in one embodiment of the invention, task scheduler 102 attempts to schedule the particular task on a machine that is not currently overloaded with work. If such a machine exists in the set of machines that currently store the portions of the data set on which the particular task needs to operate, then task scheduler 102 assigns the particular task to that machine. However, if all of the machines in the set of machines that currently store the portions of the data set on which the particular task needs to operate, then task scheduler 102 selects, from among machines 104A-N, a machine that is not currently overloaded with work, even though that machine does not currently store copies of all of the portions of the data set on which the particular task needs to operate.

In response a particular machine of machines 104A-N being assigned a task from task scheduler 102, that particular machine determines whether copies of all of the portions of the data set on which the task needs to operate are currently stored on the particular machine's persistent storage mechanism (initially, at least one copy of each portion of the data set is stored on at least one of machines 104A-N, although, at any point in time, the entire data set might not be stored on any single one of machines 104A-N). If any portions on which the task needs to operate are not currently stored on the particular machine's persistent storage mechanism, then the particular machine asks metadata server 106 to provide information that indicates the set of machines that currently store copies of the needed portions that are not currently stored on the particular machine's persistent storage mechanism. Metadata server 106 responsively responds with information that indicates this set of machines. The particular machine then asks machines that currently store the needed portions to ship those portions over network 108 to the particular machine. Those machines responsively ship the needed portions to the particular machine.

As is discussed above, when the needed portions of the data set are shipped to the particular machine, the particular machine makes persistent copies of those portions on the particular machine's persistent storage mechanism, thereby replicating those portions. The particular machine notifies metadata server 106 that the particular machine now also persistently stores those portions. Metadata server 106 responsively updates the global information to indicate that the particular machine now persistently stores those portions.

In one alternative embodiment of the invention, the particular machine to which the needed portions of the data set are shipped only makes persistent copies of those portions under certain specified circumstances. For example, in one such alternative embodiment of the invention, a human user specifies an override of an “always make persistent” policy for certain portions of the data set. In one alternative embodiment of the invention, a user associates, with one or more portions of the data set, a probability that the machine to which any of those portions are shipped should use to determine whether to create a persistent copy of those portions on the machine's local storage device. For example, a portion that is associated with a probability of 100% would always be stored on the local storage device of the machine to which that portion was shipped, while a portion that is associated with a probability of 0% would never be stored on the local storage device of the machine to which that portion was shipped. Probabilities could also be set between 0% and 100%. In some cases, a machine might request a file that will only be useful for a task that the machine is currently running. Because the machine might never use that file again, it might be more beneficial under such circumstances to refrain from creating a persistent local copy of the file on the machine.

### Example Replication Technique Locally Performed on a Machine

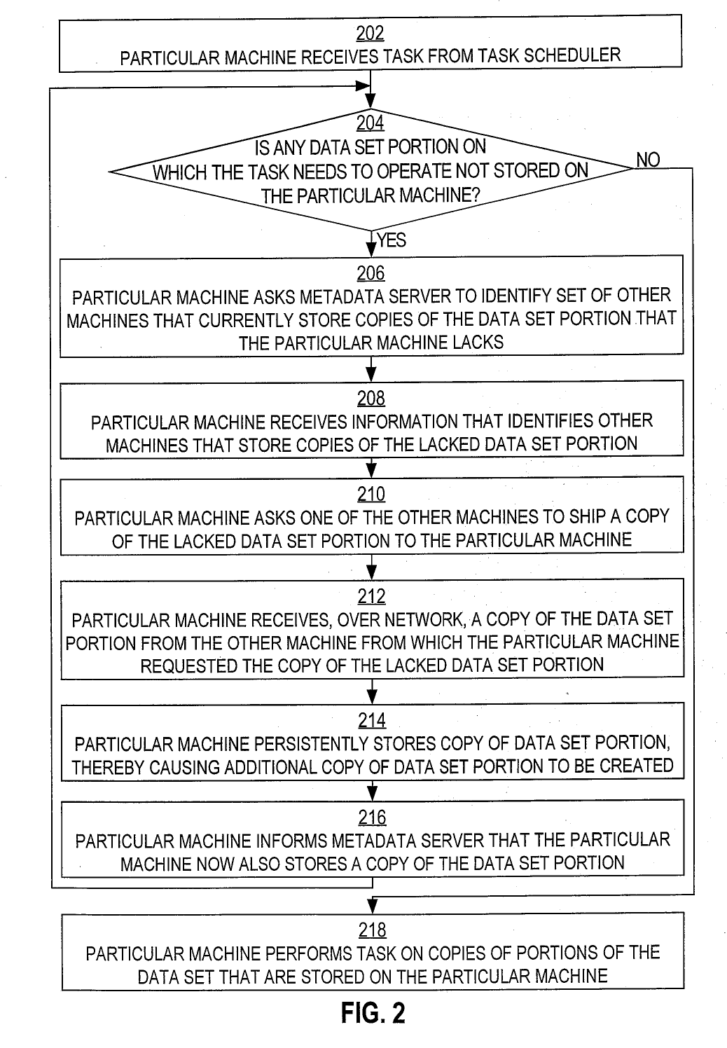

FIG. 2 is a flow diagram that illustrates an example of a replication technique that may be performed locally by any or all of machines 104A-N, according to an embodiment of the invention. Although certain steps are illustrated in the example technique shown in FIG. 2, alternative embodiments of the invention may involve more, fewer, or different steps than those specifically shown.

In block 202, a particular machine (of machines 104A-N) receives a task from task scheduler 102. The task specifies one or more portions of the data set on which the task needs to operate. For example, the task may specify one or more files upon whose data the task needs to perform operations (e.g., join operations, sort operations, etc.). As is discussed above, task scheduler 102 might assign the task to the particular machine due to the particular machine not currently being overloaded with work, even though the particular machine might not currently store all of the portions of the data set on which the task needs to operate.

In block 204, the particular machine determines whether any portion of the data set on which the task needs to operate is not currently stored on the particular machine's persistent storage mechanism. If any portion of the data set on which the task needs to operate is not currently stored on the particular machine's persistent storage mechanism, then control passes to block 206. Otherwise, control passes to block 218.

In block 206, the particular machine asks metadata server 106 to identify the set of other machines that currently store copies of a portion that the particular machine currently lacks. For example, the particular machine may send a request to metadata server 106 over network 108.

In block 208, the particular machine receives, from metadata server 106, information that identifies the set of other machines that currently store copies of the portion that the particular machine currently lacks. For example, metadata server 106 may send this information to the particular machine over network 108.

In block 210, the particular machine asks one of other machines, in the set of other machines identified by metadata 106, to ship, to the particular machine, a copy of the portion that the particular machine currently lacks. For example, the particular machine may send a request to the other machine over network 108.

In block 212, the particular machine receives a copy of the requested portion of the data set from the other machine from which the particular machine requested the copy. For example, the particular machine may receive a copy of a requested file from the other machine over network 108. The other machine may send the copy of the requested file to the particular machine using file transfer protocol (FTP), for example.

In block 214, the particular machine persistently stores the received copy of the requested portion of the data set on the particular machine's persistent storage mechanism. For example, the particular machine may store a received copy of a file on the particular machine's hard disk drive.

In block 216, the particular machine informs metadata server 106 that the particular machine now currently stores the received copy of the portion of the data set. For example, the particular machine may send, over network 108, to metadata server 106, information that indicates that the particular machine now persistent stores a copy of a file. As is discussed above, in response to the receipt of such information, metadata server 106 updates (in at least one embodiment of the invention) the global information that describes which of machines 104A-N currently store copies of various portions of the data set. Control then passes back to block 204, in which a determination is made as to whether the particular machine still lacks any other portions of the data set on which the task needs to operate.

Alternatively, in block 218, the particular machine locally performs the task on copies of the portion of the data set that are stored on the particular machine's persistent storage mechanism.

### Example Eviction Technique Locally Performed on a Machine

Replication is useful for ensuring that no single machine of the distributed system will be overloaded with tasks that need to operate on an especially popular portion of the data set. However, due to the physical capacity limitations of the persistent storage mechanisms of machines 104A-N, it is sometimes not possible for multiple copies of each portion of the data set to be replicated among machines 104A-N. Sometimes, it is preferable to have many copies of an especially popular portion of the data set stored among machines 104A-N, but to have only a few (if not only one) copies of less popular portions of the data set stored among machines 104A-N. Inasmuch as the extent to which a particular portion of the data set should be replicated might change over time, in certain embodiments of the invention, machines 104A-N each employ an eviction technique. Use of the eviction technique allows machines 104A-N to remove, from their persistent storage mechanisms, currently less popular copies of portions of the data set so that those machines have room to store copies of the data set that are currently more popular.

In one embodiment of the invention, each particular machine of machines 104A-N maintains a separate numerical “utility measure” in association with each copy of the data set that the particular machine stores on its persistent storage mechanism. In response to a task operating on a particular copy of a portion of the data set, the particular machine on which the particular copy is stored increments the utility measure (e.g., by adding one to a value that the utility measure currently represents) associated with that particular copy. Thus, if a particular copy of a portion of the data set is frequently accessed (operated upon by tasks) on a particular machine, then the utility measure that is associated with that particular copy on the particular machine will be incremented frequently also.

In one embodiment of the invention, each particular machine of machines 104A-N periodically decrements the utility measure of each data set portion copy that is stored on that particular machine. For example, in one embodiment of the invention, every minute (or some other specified interval of time), and for each data set portion copy that is currently stored on machine 104A, machine 104A decrements the utility measure (e.g., by subtracting one from the value that the utility measure currently represents) that is associated with that data set portion copy. Thus, the utility measures are said to be “decaying” utility measures. Even if a particular copy of a portion of the data set once had a high utility measure due to being frequently accessed in the past, the particular copy's utility measure will gradually decline if that particular copy ceases to be frequently accessed in the future.

In one embodiment of the invention, each particular machine of machines 104A-N periodically determines whether that particular machine's persistent storage mechanism has been filled up beyond a specified threshold (e.g., 90% of total storage capacity). In response to a particular machine determining that its persistent storage mechanism has been filled up beyond the specified threshold, the particular machine selects one or more copies of portions of the data set that are currently stored on the particular machine, and evicts those copies from the particular machine's persistent storage mechanism. In one embodiment of the invention, the particular machine selects, for eviction, the data set portion copies that are associated with the lowest utility measures among all of the data set portion copies that are currently stored on the particular machine's persistent storage mechanism. In one embodiment of the invention, the particular machine selects enough files for eviction that removing those files from the particular machine's hard disk drive will increase the available free capacity of the hard disk drive to a certain amount, or to a certain percentage of the hard disk drive's total capacity. This amount may be unrelated to the specified threshold in certain embodiments of the invention.

In one embodiment of the invention, before selecting a particular copy of a portion of the data set for eviction, the particular machine first asks metadata server 106 whether a specified minimum number of copies of that portion exists among machines 104A-N. For example, a system operator might store, on metadata server 106, a rule that states that two copies of each portion of the data set (and/or a certain other specified number of copies of a certain specified portion of the data set) must always remain stored among machines 104A-N. In one embodiment of the invention, a particular copy of a particular portion of the data set is not allowed to be selected for eviction if the particular copy of the particular portion is the only existing copy of the particular portion currently stored on any of machines 104A-N (so that no portion of the data set is ever entirely deleted). If metadata server 106 responds that the number of copies of a particular portion is already at the specified minimum number of copies that are required to exist among machines 104A-N, then the particular machine refrains from selecting the copy of that particular portion for eviction, and instead attempts to select a copy of another portion of the data set for eviction.

In one embodiment of the invention, after selecting a set of data set portion copies for eviction, the particular machine removes those data set portion copies from the particular machine's persistent storage mechanism (e.g., by deleting selected copies of files from the particular machine's hard disk drive). Additionally, the particular machine notifies metadata server 106 that the evicted data set portion copies are no longer stored on the particular machine's persistent storage mechanism. As is discussed above, in response to receiving such a notification, metadata server 106 updates the global information to indicate that the evicted portions are no longer persistently stored on the particular machine.

Although an embodiment of the invention is described above in which data set portion copies are selected for eviction based solely on a utility measure, in an alternative embodiment of the invention, data set portion copies are, instead, selected based on one or more additional or alternative factors. For example, in one alternative embodiment of the invention, a score for each data set portion copy is computed by dividing that data set portion copy's utility measure by that data set potion copy's size (e.g., in bytes). Thus, in such an alternative embodiment of the invention, larger data set portion copies are more prone to selection for eviction than smaller data set portion copies are. Nevertheless, a small data set portion copy still might be selected for eviction over a large data set portion copy if (a) the large data set portion copy has been frequently accessed during a most recent time interval and (b) the small data set portion copy has been accessed only infrequently during that time interval.

### Hardware Overview

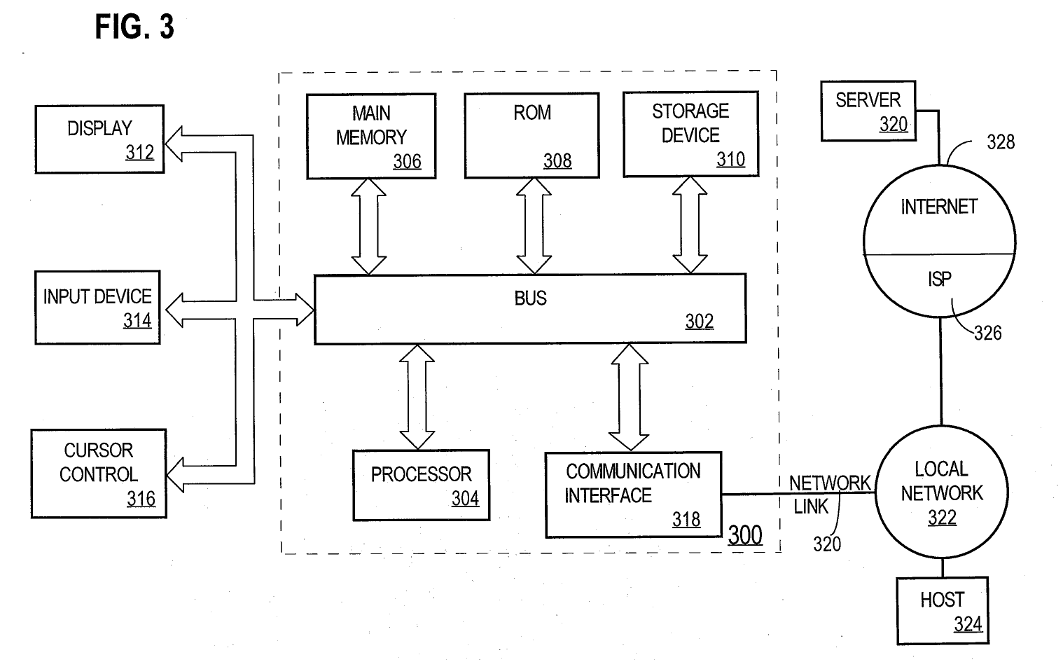

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 350 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method of peer-to-peer caching, the method comprising:
requesting, at a first storage device, a copy of a file that is stored on a second storage device but not the first storage device;
receiving the copy of the file at the first storage device from the second storage device in response to said requesting;
storing the copy of the file on the first storage device; and
publishing, to a metadata server that is separate from a machine that controls the first storage device, information that indicates that the copy of the file is available on the first storage device.

2. The method of claim 1, further comprising:
determining whether user-specified criteria associated with the file are satisfied; and
after the first storage device receives the copy of the file from the second storage device, persistently storing a non-volatile copy of the file on the second storage device only in response to determining that the user-specified criteria associated with the file are satisfied.

3. The method of claim 1, wherein publishing the information comprises sending, over a network, to the metadata server, which is accessible by both (a) a machine that controls the first storage device and (b) a machine that controls the second storage device, information that indicates that the copy of the file is stored on the second storage device.

4. The method of claim 1, wherein publishing the information comprises sending information over a network to the metadata server, which will (a) store the information in response to receiving the information and (b) make the stored information available to two or more separate machines other than the metadata server.

5. The method of claim 1, further comprising:
receiving a task at a first machine that controls the first storage device;
wherein the task needs to perform at least one operation on the file;
in response to receiving the task, determining, at the first machine, that no copy of the file is currently stored on the first storage device;
wherein the step of requesting the copy of the file from the second storage device is performed in response to the determining, at the first machine, that no copy of the file is currently stored on the first storage device.

6. The method of claim 5, further comprising:
in response to determining, at the first machine, that no copy of the file is currently stored on the first storage device, sending to the metadata server a request for particular information that indicates a set of machines on which a copy of the file is currently stored; and
receiving, from the metadata server, particular information that indicates the set of machines on which a copy of the files is currently stored;
wherein the set of machines includes a machine that controls the second storage device.

7. The method of claim 5, wherein the step of receiving the task at the first machine comprises receiving the task from a task scheduling mechanism that selected the first machine to perform the task due at least in part to the first machine having less than a threshold amount of work to do, even though the first storage device did not store any copy of the file at a time that the task scheduling mechanism selected the first machine to perform the task.

8. The method of claim 1, further comprising:
determining that the first storage device is filled beyond a threshold level of the first storage device's capacity;
in response to determining that the first storage device is filled beyond the threshold level, selecting, for eviction, one or more files that are stored on the first storage device; and
deleting, from the first storage device, the one or more files that were selected for eviction.

9. The method of claim 8, wherein the step of selecting the one or more files for eviction comprises:
determining a separate utility measure for each file that is stored on the first storage device; and
selecting, from among the files that are stored on the first storage device, one or more files that are associated with lowest utility measures of utility measures that are associated with the files that are stored on the first storage device;
wherein, for each particular file that is stored on the first storage device, the utility measure associated with that particular file is determined based at least in part on (a) an amount of time that has passed since the particular file was last accessed and (b) a number of times that the particular file was accessed.

10. The method of claim 8, wherein the step of selecting the one or more files for eviction comprises:
determining, for a particular file that is stored on the first storage device, a number of copies of the particular file are currently stored among a plurality of storage devices that includes the first storage device;
determining a specified minimum number of copies of the particular file that are required to be stored among the plurality of storage devices at all times;
determining whether the number of copies of the particular file that are currently stored among the plurality of storage devices is greater than the specified minimum number of copies; and
in response to determining that the number of copies of the particular file that are currently stored among the plurality of storage devices is greater than the specified minimum number of copies, selecting only files other the particular file for eviction from the first storage device.

11. The method of claim 1, further comprising:
in response to an operation being performed on a first file that is stored on the first storage device, incrementing a utility measure that is associated with the first file; and
in response to a specified amount of time passing since the first file was last accessed, decrementing the utility measure that is associated with the first file.

12. A volatile or non-volatile computer-readable storage medium carrying one or more sequences of instructions which, when executed by one or more processors, cause the one or more processors to perform the steps recited in claim 1.

13. A volatile or non-volatile computer-readable storage medium carrying one or more sequences of instructions which, when executed by one or more processors, cause the one or more processors to perform the steps recited in claim 2.

14. A volatile or non-volatile computer-readable storage medium carrying one or more sequences of instructions which, when executed by one or more processors, cause the one or more processors to perform the steps recited in claim 3.

15. A volatile or non-volatile computer-readable storage medium carrying one or more sequences of instructions which, when executed by one or more processors, cause the one or more processors to perform the steps recited in claim 4.

16. A volatile or non-volatile computer-readable storage medium carrying one or more sequences of instructions which, when executed by one or more processors, cause the one or more processors to perform the steps recited in claim 5.

17. A volatile or non-volatile computer-readable storage medium carrying one or more sequences of instructions which, when executed by one or more processors, cause the one or more processors to perform the steps recited in claim 6.

18. A volatile or non-volatile computer-readable storage medium carrying one or more sequences of instructions which, when executed by one or more processors, cause the one or more processors to perform the steps recited in claim 7.

19. A volatile or non-volatile computer-readable storage medium carrying one or more sequences of instructions which, when executed by one or more processors, cause the one or more processors to perform the steps recited in claim 8.

20. A volatile or non-volatile computer-readable storage medium carrying one or more sequences of instructions which, when executed by one or more processors, cause the one or more processors to perform the steps recited in claim 9.

21. A volatile or non-volatile computer-readable storage medium carrying one or more sequences of instructions which, when executed by one or more processors, cause the one or more processors to perform the steps recited in claim 10.
